(19) United States
(12) Patent Application Publication
(10) Pub. No.: US 2017/0001902 A1
(43) Pub. Date: Jan. 5, 2017

(54) METHOD OF MAKING A RED-GLASS VESSEL

(71) Applicant: SAINT-GOBAIN OBERLAND AG, Bad Wurzach (DE)

(72) Inventors: Harald ZIMMERMANN, Bad Wurzach (DE); Khaled AL HAMDAN, Freiberg (DE)

(21) Appl. No.: 15/114,535

(22) PCT Filed: Feb. 26, 2015
(86) PCT No.: PCT/EP2015/000456

§ 371 Date: Jul. 27, 2016

(30) Foreign Application Priority Data
Mar. 26, 2014 (DE) 10 2014 004 332.0

(51) Int. Cl. C03C 1/10; C03B 29/02; C03C 1/00; C03C 3/00; C03C 4/02

(52) U.S. Cl. CPC C03C 1/105; C03C 3/00; C03C 4/02; C03C 1/004; C03B 29/02; C03C 2204/00

(57) ABSTRACT

In order to provide a method which can produce red glass vessels and which is attended by low cost in respect of the raw materials/starting materials and also in respect of control of process parameters, an appropriate method for producing red glass vessels is proposed in which a colourless molten glass composition containing at most 3% by mass of tin oxide and at most 3% by mass of copper oxide is produced, where the resultant colourless molten glass composition is refined under neutral conditions with sodium sulphate and/or calcium sulphate and with a carbon-containing reducing agent with a molar carbon/sulphate ratio of from 0.5 to 5, where glass vessels are moulded from said refined glass composition, and where the glass vessels are cooled to a temperature of below 520 degrees C. to 580 degrees C.

The invention relates to a method of making a red-glass container.

Different corresponding methods of making a red-glass container are known from the prior art. These known methods, however, are elaborate either in terms of their requirements on the starting material or on the control of the parameters during the production process.

A method of this type of making red copper ruby glass or red-colored borosilicate glass is known from DE 10 2004 001 729 A1.

The object of the invention is to provide a method of making a red-glass container in which, on the one hand, starting materials or raw materials that can be obtained at a comparatively low economical cost and that are also food grade materials can be used, wherein, in addition, the control and regulation of the parameters to be observed during the production method is accompanied by a low level of effort.

This object is achieved in accordance with the invention by a method of making a red-glass container, wherein a colorless molten glass composition containing from 0.2 to 3% by mass of tin oxide and from 0.06 to 3% by mass of copper oxide is produced, wherein the produced colorless molten glass composition is refined under neutral conditions with sodium sulphate and/or calcium sulphate and with a carbon-containing reducing agent with a molar carbon/sulphate ratio of from 0.5 to 5, wherein glass containers are molded from the glass composition refined under neutral conditions, and in which the glass containers are cooled to a temperature of below 520° C. to 580° C. With the method according to the invention, the requirements on the starting material or the raw materials are considerably reduced compared to the prior art. By way of example, there are no requirements to be met or satisfied in terms of the sulphide content of the starting material. Those method parameters that must be observed imperatively for the success of the production process according to the invention can be held within the admissible value ranges with a comparatively low control and regulation effort.

In the method according to the invention, activated carbon can advantageously be used as carbon-containing reducing agent, wherein, as a result of the use of activated carbon, the molar carbon/sulphate ratio can be adjusted or maintained at the necessary ratio with an extremely low level of effort.

It has proven to be advantageous when the content of tin oxide is 0.5 to 1.5% by mass, preferably approximately 1% by mass, and the content of copper oxide is 0.1 to 0.35% by mass, preferably approximately 0.2% by mass, wherein the economical outlay can be considerably reduced further still.

With regard to the molar carbon/sulphate ratio to be observed, it has proven to be particularly advantageous when the produced colorless molten glass composition is refined under neutral conditions with sodium sulphate and/or calcium sulphate and with activated carbon with a molar carbon/sulphate ratio of from 0.5 to 2, preferably of approximately 1.0.

The use of tin oxide and copper oxide in the colorless molten glass composition can be reduced when the glass containers cooled below the temperature of from 520° C. to 580° C. are subjected to a secondary heat treatment, preferably at approximately 620 degrees C.

When the colorless molten glass composition is produced with phosphates, preferably calcium phosphates and in particular with di-calcium phosphate and/or tri-calcium phosphate, the glass network can be advantageously modified in order to accelerate the annealing or tarnishing process and/or in order to keep temperatures necessary for the execution of the method as low as possible. Here, calcium phosphates, in particular di-calcium phosphate and/or tri-calcium phosphate, have proven to be particularly advantageous, since they are pH-neutral and are absolutely non-toxic. Both di-calcium phosphate and tri-calcium phosphate occur with a low fluorine content and can be used advantageously in this form for the method according to the invention, since high fluorine contents are associated with disadvantages in the case of the method according to the invention. Di-calcium phosphate, also known as calcium hydrogen phosphate, is usually mined and is additionally created as waste material in the foodstuffs industry. Tri-calcium phosphate, also known as spodium or bone ash, likewise can be mined and is additionally obtainable as waste or residual material and, similarly to di-calcium phosphate, can be used and exploited as raw material in the method according to the invention.

Is also possible to produce the colorless molten glass composition with boric acid, wherein this also serves to modify the glass network in order to accelerate the annealing or tarnishing process and/or to minimize the tarnishing temperatures.

A content of from approximately 0.01 to 5% by mass has proven to be particularly advantageous both in terms of the phosphates and in terms of the boric acids.

For accelerated nucleation, it has proven to be expedient when the colorless molten glass composition is produced with metal compounds and/or heavy metal compounds, such as PbO and/or PbS and/or Bi₂O₃ and/or Bi₂S₃, wherein BiO₂ has proven to be the least objectionable of all heavy metals and has therefore proven to be particularly advantageous.

With regard to the content by mass of the above-described substances in the colorless molten glass composition, a content of PbO and/or PbS and/or Bi₂O₃ and/or Bi₂S₃ of, in each case, 0.01 to 3% by mass has proven to be particularly advantageous.

A red-glass container produced accordingly are advantageously suitable in particular as containers for foodstuffs and/or beverages.

In the refinement under neutral conditions performed in the case of the invention, the glass melt is adjusted such that it is neither oxidizing nor reducing.

The invention will be explained in greater detail hereinafter on the basis of an embodiment.

A colorless molten glass compound is firstly produced from suitable raw materials and serves as starting material for the method according to the invention. Tin oxide and copper oxide are contained in the glass composition, wherein the content of tin oxide is approximately 1% by mass and the content of copper oxide is approximately 0.2% by mass.

Di-calcium phosphate and/or tri-calcium phosphate are/is also contained in the glass composition, wherein the content of di-calcium phosphate and/or tri-calcium phosphate is approximately 0.01 to 5% by mass.

Alternatively or additionally to the tri-calcium phosphate, the colorless molten glass composition can contain boric acid, wherein a range of from 0.01 to 5% by mass has proven to be particularly advantageous in view of the content of boric acid as well.

The phosphate and/or the boric acid serve/serves to modify the glass network so that the annealing or tarnishing process can be accelerated and the necessary tarnishing temperatures can be kept as low as possible.

In order to accelerate the nucleation, the colorless molten glass composition is produced with Bi2O3, more specifically with a content between 0.01 and 3% by mass.

Instead of Bi₂O₃, PbO and/or PbS and/or Bi₂S₃ can also be used for the same purpose.

What is essential in the case of the above-described materials is that they are metal compounds or heavy metal compounds that can easily precipitate out in the metallic state under the redox conditions provided in the glass melt.

The colorless molten glass composition is refined under neutral conditions with sodium sulphate and/or calcium sulphate and with activated carbon. Here, a molar carbon/sulphate ratio of approximately 1.0 is observed.

By the methods known from the prior art, glass containers are molded from the glass composition refined accordingly under neutral conditions.

Once the molding of the glass containers is complete, these are cooled to a temperature of below 520 degrees C. to 580° C.

In the described illustrated embodiment of the method according to the invention, a secondary heat treatment is performed following this cooling and is carried out at approximately 620° C. The glass containers produced accordingly are then cooled. At the end of the above-described production method, the glass containers have the desired red coloration. They are also suitable in particular for receiving foodstuffs or beverages.

1. A method of making a red-glass container, the method comprising the steps of:
making a colorless molten glass composition containing at most 3% by mass of tin oxide and at most 3% by mass of copper oxide;
refining the colorless molten glass composition under neutral conditions with sodium sulphate or calcium sulphate and with a carbon-containing reducing agent with a molar carbon/sulphate ratio of from 0.5 to 5;
molding a glass container from the glass composition refined under neutral conditions; and
cooling the glass container to a temperature of below 520° C. to 580° C.

2. The method according to claim 1, wherein activated carbon is used as carbon-containing reducing agent.

3. The method according to claim 1, wherein the colorless molten glass composition is made with a content of tin oxide of from 0.2 to 3% by mass and with a content of copper oxide of from 0.06 to 3% by mass.

4. The method according to claim 3, wherein the colorless molten glass composition is made with a content of tin oxide of from 0.5 to 1.5% by mass and with a content of copper oxide of from 0.1 to 0.35% by mass.

5. The method according to claim 1, wherein the colorless molten glass composition is refined under neutral conditions with sodium sulphate or calcium sulphate and with activated carbon with a molar carbon/sulphate ratio of from 0.5 to 2.

6. The method according to claim 1, further comprising the step of:
heat-treating the glass container cooled below a temperature of from 520° C. to 580° C. at approximately 620° C.

7. The method according to claim 1, further comprising the step of:
making the colorless molten glass composition di-calcium phosphate or tri-calcium phosphate.

8. The method according to claim 7, wherein the colorless molten glass composition is made with a content of phosphates of from 0.01 to 5% by mass.

9. The method according to claim 1, wherein the colorless molten glass composition is made with boric acid.

10. The method according to claim 9, wherein the colorless molten glass composition is made with a content of boric acid of from 0.01 to 5% by mass.

11. The method according to claim 1 wherein the colorless molten glass composition is made with PbO or PbS pr Bi₂O₃ or Bi₂S₃.

12. The method according to claim 11, wherein the colorless molten glass compound is made with a content of PbO or PbS or Bi₂O₃ and/ or Bi₂S₃ of 0.01 to 3% by mass.

13. Use of a red-glass container made in accordance with any claim 1 as a container for foodstuffs or beverages.
